(19) United States
(12) Patent Application Publication
(10) Pub. No.: US 2005/0019720 A1
(43) Pub. Date: Jan. 27, 2005

(54) Orthodontic wire retainer

(76) Inventor: Toshio Harima, Kihei, HI (US)

Correspondence Address: Hoffman, Wasson & Gitler, P.C., Suite 522, 2361 Jefferson Davis Highway, Arlington, VA, 22202, US

(21) Appl. No.: 10/625,531

(22) Filed: Jul. 24, 2003

(51) Int. Cl. A61C 3/00

(52) U.S. Cl. 433/18

(57) ABSTRACT

An orthodontic wire retainer is applied to a dental arch following an orthodontic treatment. A first metal wire extends along the posterior surface of the dental arch, a second metal wire extends along the anterior surface, and a third wire fits between a bicuspid and premolar or between the premolar and a molar. The first, second and third wires are adjoined to provide an annular bridge supporting the dental arch. A wire clasp laid along the buccal surface of the premolar attaches to the first metal wire to sustain strength of the wire retainer by attaching a wire rest on the premolar or molar to prevent sinking of the wire retainer.

### FIELD OF THE INVENTION

This invention relates to an orthodontic wire retainer. More particularly, the present invention relates to an orthodontic wire retainer kept in place following an orthodontic treatment of the dental arch, until fixation of the arch.

### BACKGROUND OF THE INVENTION

Following an orthodontic treatment of the dental arch, an orthodontic retainer is set in position for a fairly long time. If the dental arch is allowed to stand, it will return to pretreatment condition, resulting in a relapse. A retainer is mounted on the dental arch to prevent such a relapse. A conventional retainer made from such material as metal wire is the subject of U.S. Pat. No. 4,725,230 and is shown in FIG. 1. The orthodontic wire retainer has a first metal wire 11 laid along the posterior surface of a dental arch, a second metal wire 12, laid along the anterior surface of the dental arch, and a third metal wire 13, fitted between a bicuspid 20 and premolar 30, or between the premolar 30 and a molar 40. The first and second metal wires fuse to the third metal wire to constitute an annular bridge 13, providing a resilient support for the dental arch 10.

It is an object of the invention to provide an orthodontic wire retainer for application to a dental arch to prevent a return to the pretreatment condition.

It is another object of the invention to provide a retainer having a clasp and rest to prevent sinking of the wire retainer.

It is another object of the invention to provide a retainer that may be kept in place for an extended period of time.

It is another object of the invention to provide a wire retainer that is comfortable for the patient.

These and other objects of the invention will become apparent to one of ordinary skill in the art, after reading the disclosure of the invention.

### SUMMARY OF THE INVENTION

An orthodontic wire retainer is applied to a dental arch following an orthodontic treatment. A first metal wire extends along the posterior surface of the dental arch, a second metal wire extends along the anterior surface, and a third wire fits between a bicuspid and premolar or between the premolar and a molar. The first, second and third wires are adjoined to provide an annular bridge supporting the dental arch. A wire clasp laid along the buccal surface of the premolar attaches to the first metal wire to sustain strength of the wire retainer by attaching a wire rest on the premolar or molar to prevent sinking of the wire retainer.

### BRIEF DESCRIPTION OF THE DRAWINGS

FIG. 1 depicts a prior art wire retainer;

FIG. 2 depicts a perspective view of the retainer of the invention;

FIG. 3 is a side view of the retainer wire clasp; and

FIG. 4 is a top view of the retainer section having the wire clasp and wire rest.

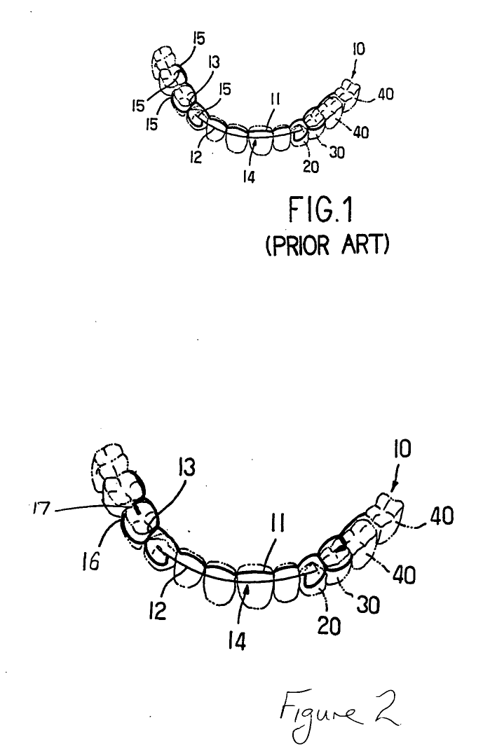

### DETAILED DESCRIPTION OF THE PREFERRED EMBODIMENTS

FIG. 2 is a front perspective view of the wire retainer. The wire retainer has a first wire 11, extending along the posterior surface of the dental arch 10, a second wire 12, extending in a loop along the anterior surface of the dental arch 10, and a third wire 13, fitting between a bicuspid tooth 20 and a premolar 30 and attached to the first and second wires 11, 12. Once joined, the first, second and third wires form an integral bridge 14, providing resilient support for the arch. The support forms a dental arch bracing appliance, transmitting orthodontic pressure. The wire can be made from any appropriate metal, such as stainless steel or gold.

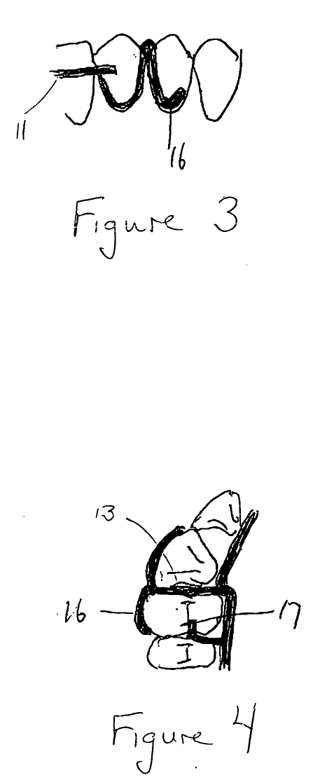

Both terminal ends of the first wire 11, second wire 12 and third wire 13, are curved along the surfaces of the molar 40, premolar 30 and bicuspid 20 on each side of the dental arch to prevent sinking of the wire, with respect to the dental arch. While the third wire is shown between canine 20 and premolar 30, it may be positioned between the premolar 30 and molar 40. To further prevent sinking of the wire retainer, a wire clasp 16 lays along the buccal surface of the premolar, as shown in FIG. 3. As seen n this figure, the wire clasp has a general W-shape when seen from the side. The wire clasp 16 is attached to the first metal wire 11 to sustain strength of the wire retainer. The wire clasp 16 holds both the buccal surface and lingual surface of the premolar and prevents sinking of the first metal wire.

In addition to the wire clasp 16, a wire rest 17 rests upon the premolar 40. The wire rest attaches to the first metal wire 11 and prevents elongation of the premolar and sinking of the wire retainer. The wire rest is L-shaped and has a first section extending between the premolar 30 and molar 40 and a second section resting on the top surface of the premolar 30. Of course, if the third wire 13 were positioned between the premolar 30 and molar 40, as mentioned previously, the wire rest would rest upon the molar 40.

While the invention has been described with reference to a preferred embodiment, variations and modifications would be apparent to one of ordinary skill in the art without departing from the scope of the invention. The invention is defined by the appended claims.

1. An orthodontic wire retainer, comprising
a first metal wire for conforming to the posterior surface of a dental arch;
a second metal wire for conforming to the anterior surface of the dental arch;
a pair of third metal wires extending between the first metal wire and second metal wire;
said third metal wires attached to said first and second metal wires to form an annular bridge providing a resilient support for teeth along the dental arch;
a wire rest extending from said first wire for resting upon the top surface of the dental arch, said wire rest spaced from the end of the first wire.

2. The orthodontic wire retainer of claim 1, further comprising a wire clasp.

3. The orthodontic wire retainer of claim 2, wherein said wire clasp is W-shaped.

4. The orthodontic wire retainer of claim 1, wherein said wire rest is L-shaped.

5. The orthodontic wire retainer of claim 1, wherein said wire rest has a first section attached to said first wire and extending toward said second wire.

6. The orthodontic wire retainer of claim 5, wherein said wire rest has a second section attached to said first second and extending toward said third wire.

7. The orthodontic wire retainer of claim 1, further comprising
a second wire rest extending from said first wire for resting upon the top surface of the dental arch, said wire rest spaced from the end of the first wire.

8. The orthodontic wire retainer of claim 7, wherein said second wire rest has a first section attached to said first wire and extending toward said second wire.

9. The orthodontic wire retainer of claim 8, wherein said second wire rest has a second section attached to said first second and extending toward said third wire.

10. The orthodontic wire retainer of claim 7, wherein said second wire rest is L-shaped.
